(19) United States
(12) Patent Application Publication
(10) Pub. No.: US 2021/0182796 A1
(43) Pub. Date: Jun. 17, 2021

(54) MULTI-TIER ANALYSIS OF A WORKSPACE PLATFORM FOR IDENTIFYING EXPERT RESOURCES

(71) Applicant: Citrix Systems, Inc., Fort Lauderdale, FL (US)

(72) Inventors: Shubham Mankhand, Fremont, CA (US); Anoop Kumar Agarwal, Sunnyvale, CA (US); Omkar Harishchandra Salvi, San Jose, CA (US); Ashik Bangalore Krishnachar, San Jose, CA (US); Quanmin Ye, Sunnyvale, CA (US)

(21) Appl. No.: 16/710,742

(22) Filed: Dec. 11, 2019

(51) Int. Cl. G06Q 10/10; G06F 16/2452; G06F 16/248; G06F 16/25

(52) U.S. Cl. CPC G06Q 10/105; G06F 16/252; G06F 16/248; G06F 16/24522

(57) ABSTRACT

A system, method and program product for identifying expert resources amongst users of a workspace platform. A method is provided that includes associating each user with a set of topics and providing a score for each association, wherein associations and scores are determined by analyzing self-reporting data, workspace activity and document analysis; receiving an inputted topic from a requesting user; and identifying an expert user based on a calculated score assessed to the expert user for the inputted topic.

### BACKGROUND OF THE DISCLOSURE

Large organizations typically rely on a large number of systems and people to fulfill their objectives. For example, a multi-national company may have specialized software applications and tools required for human resource management, research and development, sales and marketing, engineering, customer service, legal, etc. Along with those systems and tools, organizations rely on people and other resources within the enterprise that have expertise to handle the many different facets of the organization. The ability to easily identify and leverage such expertise can greatly improve the efficiency of such organizations.

### BRIEF DESCRIPTION OF THE DISCLOSURE

Aspects of this disclosure provide a multi-tier analysis of a workspace platform for identifying expertise within an organization. Certain aspects include the use artificial intelligence (AI) for evaluating associations between users and topics and scoring users relative to potential topics. A further aspect utilizes natural language processing (NLP) to seamlessly identify experts within the context of a user experience (UX) interface.

A first aspect of the disclosure provides a computing system having a memory and a processor coupled to the memory that implements a process for identifying experts amongst a set of users that engage with an enterprise workspace platform. The process includes associating each user with a set of topics and providing a score for each association, wherein associations and scores are determined by analyzing self-reporting data, workspace interactions and document activity. The process further includes receiving an inputted topic from a requesting user and identifying an expert user based on a calculated score assessed to the expert user for the inputted topic.

A second aspect of the disclosure provides a method for identifying experts amongst a set of users that engage with an enterprise workspace platform. The method includes associating each user with a set of topics and calculating a score for each association, wherein associations and scores are determined by analyzing self-reporting data, workspace interactions and document activity. The method further includes receiving a natural language (NL) input from a requesting user in a user experience (UX) interface, processing the NL input to determine a topic, and identifying and displaying an expert user based on scores calculated for the topic.

A third aspect of the disclosure provides a computer program product stored on a computer readable storage medium, which when executed by a computing system, implements a method for identifying experts amongst a set of resources that engage with an enterprise workspace platform. The method includes associating each resource with a set of topics and calculating a score for each association, wherein associations and scores are determined by analyzing self-reporting data, workspace interactions and document activity. The method further includes receiving an inputted topic from a requesting user and identifying an expert based on scores calculated for the inputted topic.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a computing system having an expert identification system in accordance with an illustrative embodiment.

FIG. 2 depicts a table of interaction data of a user relative to a topic at different time periods, in accordance with an illustrative embodiment.

FIG. 3 depicts the table of FIG. 2, further having scores for each time period, in accordance with an illustrative embodiment.

FIG. 4 depicts the table of FIG. 3, further having running average values in accordance with an illustrative embodiment.

FIG. 5 depicts an email interface, in accordance with an illustrative embodiment.

FIG. 6 depicts a technical support tool, in accordance with an illustrative embodiment.

FIG. 7 depicts a flow diagram of a method of identifying exerts, in accordance with an illustrative embodiment.

FIG. 8 depicts a network system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for analyzing a workspace platform to identify expert resources within an organization using an AI based multi-tier analysis. Technical solutions also include tracking and evaluating interactions with applications in the workspace platform to score associations between topics and users. Technical solutions further include the use of natural language processing (NLP) to seamlessly identify expert resources within the context a user experience (UX) interface.

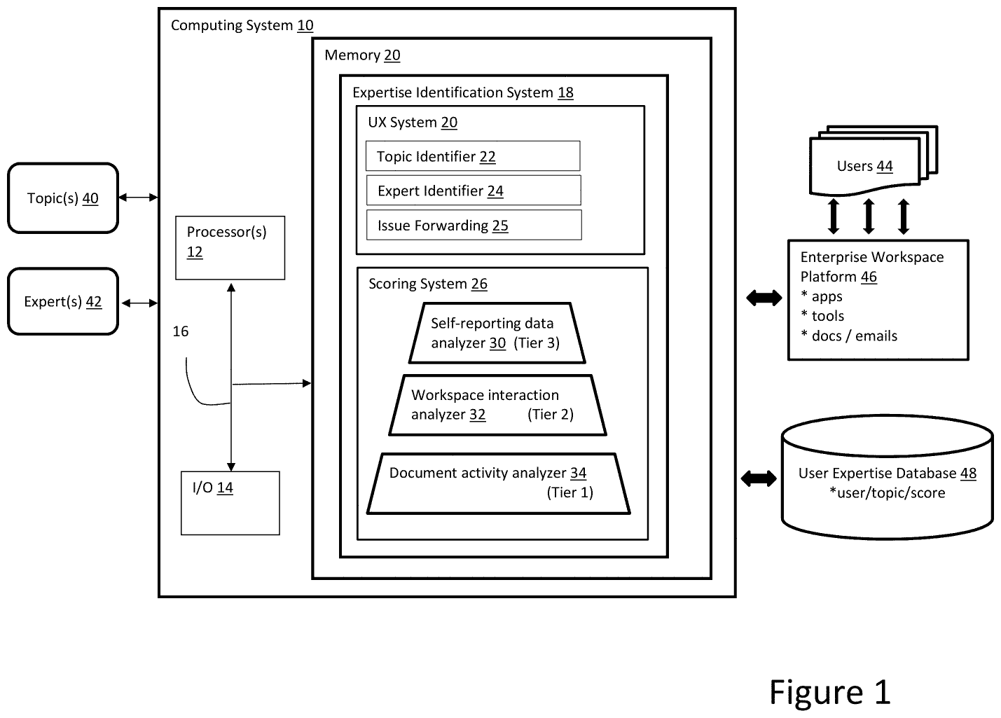

Referring to FIG. 1, a computing system 10 is shown that includes an expertise identification system 18 in which one or more experts 42 are identified based on an inputted topic. While this description is generally directed to identifying expert users (i.e., people), it is understood that the subject matter is intended to apply to identifying any type of expert resource, e.g., artificial intelligent agents, autonomous systems, Internet of Things (IoT) devices, etc. In this illustrative embodiment, expertise identification system 18 generally includes: (1) a UX system 20 that seamlessly integrates the processing of an inputted topic 40 within an enterprise tool, such as an email program, a customer service call center tool, a technical support program, etc.; and (2) a scoring system 26 that scores associations between users 44 of an enterprise workspace platform 46 and potential topics 40.

In one illustrative approach, UX system 20 may be implemented as a basic search facility in which a user enters a topic 40, e.g., via a natural language (NL) input, dropdown box, etc., and a list of experts 42 are returned. In a further illustrative embodiment, UX system 20 can be integrated with any program or software tool in which natural language (NL) or structured content is entered by the user. For example, UX system 20 may integrate with an email program in which experts are automatically identified when the user enters NL content and expertise is sought or deemed useful, e.g., the user could type “just received a report of an outage after an SSL upgrade.” In this case, UX system 20 automatically discerns a topic from the NL input, identifies experts, and emails the issue to the identified experts.

To implement this functionality, UX system 20 generally includes: a topic identifier 22 that utilizes NLP to extract one or more topics 40 from an NL input; an expert identifier 24 that identifies one or more experts 42 from a user expertise database 48 based on the extracted topic(s) 40; and an issue forwarding system 25 that forwards a request for expert assistance (e.g., the NL input) to the identified expert(s) 42.

Experts are obtained for a given topic by submitting the topic to a user expertise database 48. User expertise database 48 is populated with scoring information for users 44 of an enterprise workspace platform 46 for their expertise relative to potential topics 40. In particular, user expertise database 48 includes associations between users and topics that are scored based on expertise level by scoring system 26.

In this illustrative embodiment, scoring system 26 utilizes a multi-tier analysis to generate scoring information for user/topic combinations. Scoring system 26 includes a self-reporting data analyzer 30 (tier 3), a workspace activity analyzer 32 (tier 2) and a document analyzer 34 (tier 1). Scoring information gathered from each tier is in turn used to formulate a score for users relative to different topics.

Self-reporting data analyzer 30 (tier 3) generally evaluates static expertise information provided by users 44. For example, every six months, users 44 of an organization may be required to update a summary of their areas of expertise in the database 48 (e.g., programming languages, projects, customer relationships, etc.). Each area of expertise may be associated with a topic tag and, e.g., an expertise value provided by the user such as high, medium and low. Thus for instance, a user may have self-reported scoring information as follows:

#Ruby(user n)=low

#IT_migration(user n)=high

#CustomerX(user n)=medium

A typical user might for example self-report on 10 or so topics. Generally, scoring information from tier 3 would tend to have a high level of accuracy.

Workspace interaction analyzer 32 (tier 2) tracks user interactions with resources provisioned (i.e., made available) by the enterprise workspace platform 46, such as use of applications, tools, documents, videos, social media, etc. Based on the number and type of interactions, scoring information is tallied for different topics for the user. For example, interaction counts with a human resource (HR) application, or aspects of the HR application, by a user can be tracked and assigned to a relevant topic tag. For instance, if a user n visited the HR application 19 times in a given period, a count value of 19 could be assigned to an associated topic tag for the user, e.g., #HR(user n)=19. Accordingly, a person frequently using the HR application will be considered to have more expertise in the field of HR than another person that never uses the HR application. Over time however, the scoring information will “decay” if the rate of use of the HR application decreases for the user. Thus, a user that has not used the HR application in a while will be considered less likely to have expertise than others who more recently used the application.

In addition to interactions with a given resource such as the HR application, interactions within a particular resource can also be tracked. For example, a particular user might frequently visit the “benefits” and “401k” features of the HR application, but rarely spend any time on the “employee management tools” features of the application. This would indicate some level of expertise with employee benefits but not with employee management. Accordingly, based on visitation frequency (or time spent) on the features, more granular level topic tags and scoring information can be tracked, e.g., #HR_benefits(user n)=15 and #HR_management(user n)=1 would indicate that user n has expertise with benefits but not management.

In an illustrative embodiment, a user might have approximately 100 or so topics maintained to collect scoring information at the tier 2 level based on their recent interactions. In order to increase scoring accuracy, semi-supervised machine learning could be utilized. For instance, based on feedback or training data, it might be determined that certain areas of expertise tend to decay faster than others under certain circumstances. For example, users that regularly interface with only one programming platform tend to lose expertise for that platform faster than those users who regularly interface with multiple programming platforms. Thus, a decay factor could be determined and adjusted based on the expertise areas for a user as determined by machine learning.

Document activity analyzer 34 (tier 1) analyzes documents (e.g., files, emails, messages, etc.) associated with the enterprise workspace platform 46 to identify associations between the user and topics. For example, a user might be listed as an author in the source code of a Ruby program, appear in an email chain regarding IT_migration, be identified as the creator of a presentation involving a legal matter, listed as an inventor on a patent, etc. In one embodiment, NLP may be utilized to analyze documents and associate a user to a topic of expertise. For instance, in the aforementioned email chain, the user might have answered a question regarding the impact of upgrading a software version for an aging firewall. In such as a case the user might be associated with the topic “firewall.” Each such association could be represented as an edge on a graph that connects a user node to a topic node. A graph containing all users, topics and connections can be maintained and processed to identify users with the most expertise for different topics. Users could be evaluated for a given topic based on the number of connections to the topic. At this tier, each user might be connected to thousands of potential topics and many users might have connections to the same topic. Accordingly, an unsupervised machine learning system could be utilized to enhance and refine scoring information. For instance, based on collected feedback, it might be determined that users connected to topic node D have greater expertise with D if they are also connected to nodes A, B and C. Thus, connections might receive a higher or lower value depending on factors learned by a machine learning algorithm.

As noted, scoring system 26 collects and processes scoring information from each tier to generate an overall score for each user/topic association. Scores may be updated or calculated in any manner and at any timeframe, e.g., in a batch mode, periodically (e.g., hourly, daily, weekly, etc.), dynamically after a user has an interaction, in response to a request for experts, etc. In one illustrative embodiment, a score for a given association can be calculated as follows. For each association Ai at each Tier i, between topic T and Person P, score S is represented as

S(T,P)=(ΣA1)*W1+(ΣA2)*W2+(ΣA3)*W3

In this case, Wi is the weight assigned for Tier i, and (ΣAi) represents the sum of all the association scores within Tier i.

As also noted, scores may decay over time, e.g., based on rate of interactions, etc. Decay may be calculated as follows in which each score for an association decays according to the following equation:

S=M(S−D1−D2−D3,MIN_{SCORE})

Here, Di is the decay at Tier i, and is calculated as

Di=DFi*abs(Tnow−TlastReferenced)

Where DFi is the decay factor for Tier i.

In one illustrative embodiment, scoring information for each tier is collected periodically at defined time intervals, e.g., at Time0, Time1, Time2 . . . TimeN. Accordingly, as time progresses more and more data points are collected for each association. In one illustrative embodiment, scoring during a time interval may comprise a number of counts, e.g., the number of times a user had an association with a topic. For instance, at Time0, counts are collected and score S is calculated for Association A as:

S(A,0,i)=Wi*AssociationCount(association=A(time=0),tier=i)

S(A,0,i)==>Score for Association A calculated at Time0 on Tier i

There are two potential factors in play: First, there may be a decay that reduces the score between TimeK and TimeK+1. For instance, if Association A exists at Time 0 but not found at Time1, then S1<S0. Conversely, if there is an association A at Time1, a new score can be calculated as follows:

S(A,1,i)=Wi*AssociationCount(association=A(time=1),tier=i)

S(A,1,i)==>Score for Association A calculated at Time1 on Tier i

Combining the two factors, the score at TimeK can be generalized as follows:

let AN(K)=AssociationCount(association=A(time=K))

let DFi be a constant defined for each tier i, where, 0<=DFi<=1.00

S(A,K,I)=(Wi*AN(K),tier=i) if AN(K)>0 else (S(A,K−1,i)−DFi)

Which provides a periodic score at each time K. A running average can be calculated as follows:

Savg(A,K,i)=(Savg(A,K−1,i)+S(A,K,i))/2

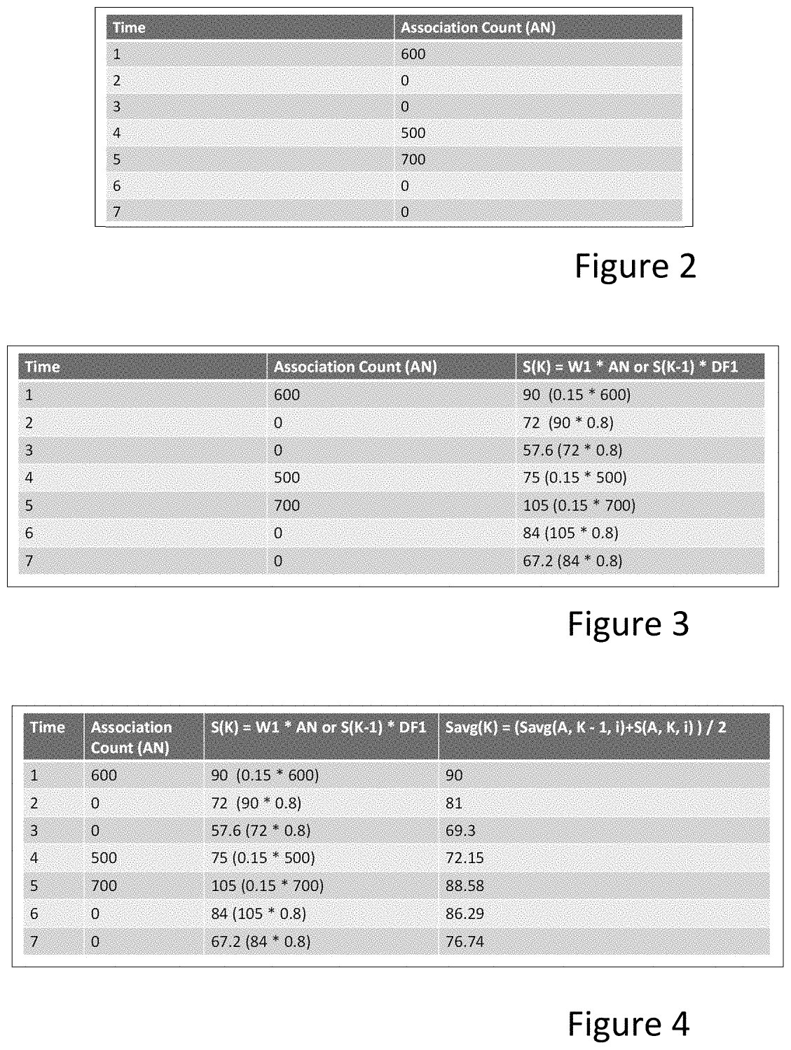

For example, FIG. 2 shows a series of time intervals (1-7) and association counts for a tier 1 analysis with weight W1=0.15 and decay factor DF1=0.80. FIG. 3 shows the resulting score S(K) at each time interval, and FIG. 4 shows the average score Savg(K) at each time interval.

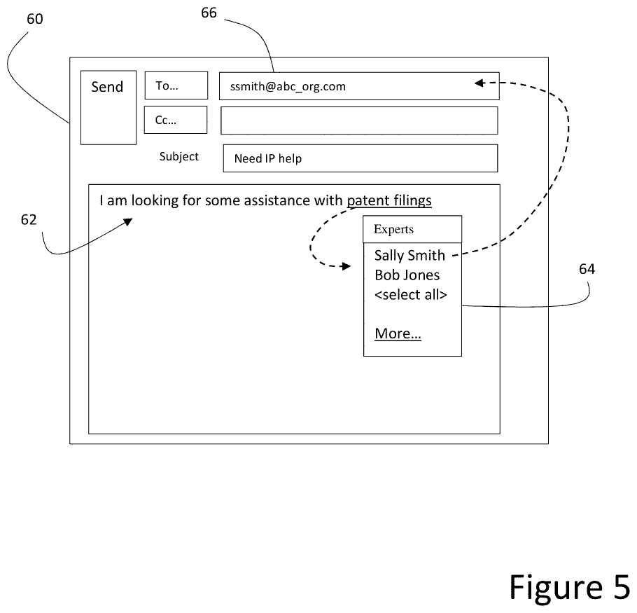

FIG. 5 depicts an illustrative UX interface 60 that integrates the identification of experts into an email program. In this embodiment, when a user types a message 62 into the body of the email, the text is analyzed to identify a topic (in this case “patent filings”). Based on the topic, one or more experts 64 are identified from the user expertise database (FIG. 1). In this case, a pop-up window is displayed with the list, from which the user can select one or more of the displayed experts. Once selected, a link to the expert, i.e., the expert's email address 66 is automatically populated into the “Send To” field of the email application. In alternative embodiments, one or more email addresses can be automatically populated into the “Send To” field without the pop-up window, i.e., experts that will receive the email are automatically selected without user input. In either case, the user can then hit the send button to forward the issue to one or more experts.

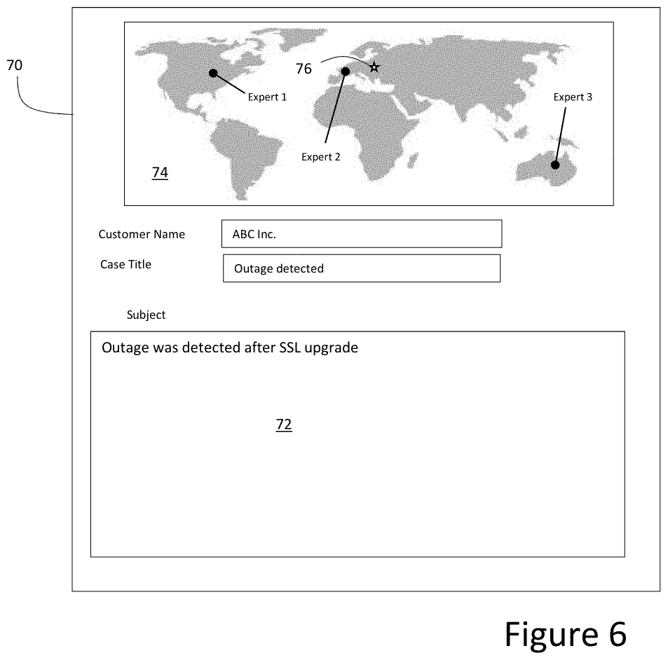

FIG. 6 depicts a further illustrative UX interface 70 that integrates the identification of experts into a customer (or technical) support tool. In this case, when a customer support representative (e.g., at a call center) opens a new case and enters a problem issue into the subject field 72, a topic is identified and a link to one or more experts is provided. In this example, the customer's location 76 as well as the location of one or more experts (Expert 1, Expert 2, Expert 3) are shown on a map 74. Additional information such as expert availability, languages spoken, etc., can also be made available. Based on the provided link, the case information can be automatically forwarded to the experts or the representative could select an expert to forward the case information.

As noted, any interface through which a user enters structured or unstructured data could be integrated within the expertise identification system 18 (FIG. 1).

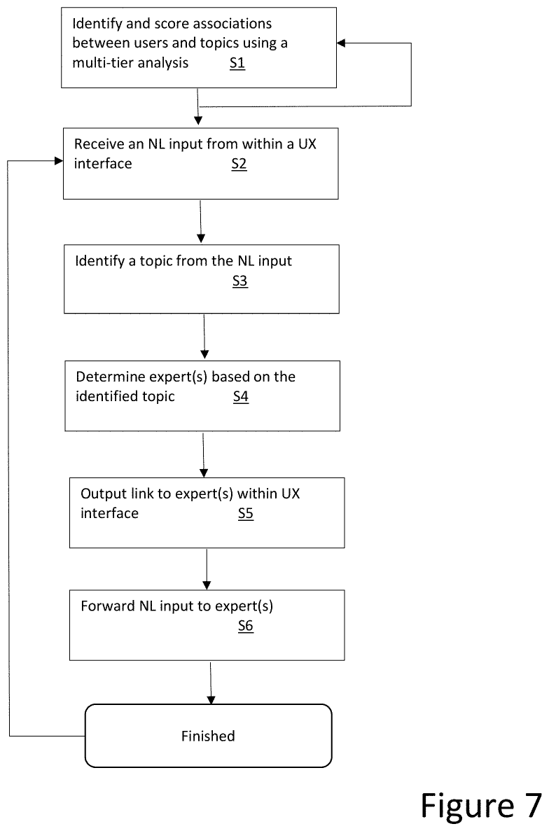

FIG. 7 depicts an illustrative flow diagram of an expert identification process. At S1, associations between users and topics are identified and scored using a multi-tier analysis. This process continuously repeats, e.g., on a periodic basis, to update associations and scores. At S2, an NL input is received from within a UX interface, such as an email program. At S3, a topic is identified from the NL input, e.g., using sentence-level text classification, a Naïve Bayes algorithm, etc. At S4, one or more experts are determined by submitting the topic to the user expertise database 48 (FIG. 1) and obtaining one or more users having the highest scores for the topic. At S5, links to the experts are provided to the UX interface for output and at S6 the NL input along with any other relevant information (e.g., requesting user's information, severity level, associated issues, etc.) are forwarded to the experts. The process then finishes and flow returns to S2, where a next NL input is evaluated.

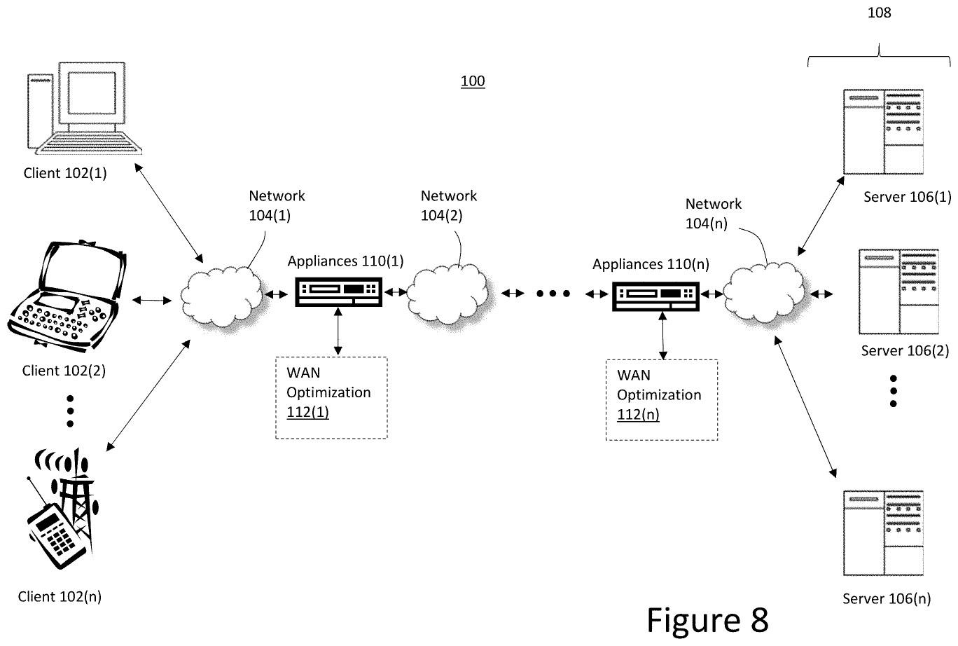

Referring to FIG. 8, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 110(1)-110n (generally referred to as appliance(s) 110 or gateway(s) 110).

Although the embodiment shown in FIG. 8 shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 8, one or more appliances 110 may be located at various points or in various communication paths of network environment 100. For example, appliance 110(1) may be deployed between two networks 104(1) and 104(2), and appliances 110 may communicate with one another to work in conjunction to, for example, accelerate network traffic between clients 102 and servers 106. In other embodiments, the appliance 110 may be located on a network 104. For example, appliance 110 may be implemented as part of one of clients 102 and/or servers 106. In an embodiment, appliance 110 may be implemented as a network device such as Citrix networking (formerly NetScaler®) products sold by Citrix Systems, Inc. of Fort Lauderdale, Fla.

As shown in FIG. 8, one or more servers 106 may operate as a server farm 108. Servers 106 of server farm 108 may be logically grouped, and may either be geographically co-located (e.g., on premises) or geographically dispersed (e.g., cloud based) from clients 102 and/or other servers 106. In an embodiment, server farm 108 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 8, in some embodiments, appliances 110 may include, be replaced by, or be in communication with, one or more additional appliances, such as WAN optimization appliances 112(1)-112(n), referred to generally as WAN optimization appliance(s) 112. For example, WAN optimization appliance 112 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 112 may be implemented as Citrix SD-WAN products sold by Citrix Systems, Inc. of Fort Lauderdale, Fla.

In described embodiments, clients 102, servers 106, and appliances 110 and 112 may be deployed as and/or executed on any type and form of computing device, such as any desktop computer, laptop computer, or mobile device capable of communication over at least one network and performing the operations described herein. For example, clients 102, servers 106 and/or appliances 110 and 112 may each correspond to one computer, a plurality of computers, or a network of distributed computers such as computing system 10 shown in FIG. 1.

Computing system 10 (FIG. 1) may for example be implemented by a cloud computing environment that employs a network of remote, hosted servers to manage, store and/or process data, and may generally be referred to, or fall under the umbrella of, a “network service.” The cloud computing environment may include a network of interconnected nodes, and provide a number of services, for example hosting deployment of customer-provided software, hosting deployment of provider-supported software, and/or providing infrastructure. In general, cloud computing environments are typically owned and operated by a third-party organization providing cloud services (e.g., Amazon Web Services, Microsoft Azure, etc.), while on-premises computing environments are typically owned and operated by the organization that is using the computing environment. Cloud computing environments may have a variety of deployment types. For example, a cloud computing environment may be a public cloud where the cloud infrastructure is made available to the general public or particular sub-group. Alternatively, a cloud computing environment may be a private cloud where the cloud infrastructure is operated solely for a single customer or organization or for a limited community of organizations having shared concerns (e.g., security and/or compliance limitations, policy, and/or mission). A cloud computing environment may also be implemented as a combination of two or more cloud environments, at least one being a private cloud environment and at least one being a public cloud environment. Further, the various cloud computing environment deployment types may be combined with one or more on-premises computing environments in a hybrid configuration.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Computing system 10 (FIG. 1) may comprise any type of computing device that for example includes at least one processor 12, memory, an input/output (I/O) 14, e.g., one or more I/O interfaces and/or devices, and a communications pathway or bus 16. In general, the processor(s) execute program code which is at least partially fixed in memory. While executing program code, the processor(s) can process data, which can result in reading and/or writing transformed data from/to memory and/or I/O for further processing. The pathway provides a communications link between each of the components in the computing device. I/O can comprise one or more human I/O devices, which enable a user to interact with the computing device and the computing device may also be implemented in a distributed manner such that different components reside in different physical locations.

Memory 20 may comprise volatile memory (e.g., RAM) and/or non-volatile memory e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof, etc. I/O 14 may include a user interface, a graphical user interface (GUI) (e.g., a touchscreen, a display, etc.) and one or more input/output (I/O) devices (e.g., a mouse, a keyboard, etc.). Computing system 10 typically may also include an operating system, additional applications, data, peripherals, etc. Computing system 10 is shown merely as an example, as clients, servers and/or appliances and may be implemented by any computing or processing environment and with any type of machine or set of machines that may have suitable hardware and/or software capable of operating as described herein.

Processor(s) 12 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

In described embodiments, a first computing device may execute an application on behalf of a user of a client computing device, may execute a virtual machine, which provides an execution session within which applications execute on behalf of a user or a client computing device, such as a hosted desktop session, may execute a terminal services session to provide a hosted desktop environment, or may provide access to a computing environment including one or more of: one or more applications, one or more desktop applications, and one or more desktop sessions in which one or more applications may execute.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computing system, comprising:
a memory; and
a processor coupled to the memory that implements a process for identifying experts amongst a set of users that engage with an enterprise workspace platform, the process including:
associating each user with a set of topics and calculating a score for each association, wherein associations and scores are determined by analyzing self-reporting data, workspace interactions and document activity;
receiving an inputted topic from a requesting user; and
identifying an expert user based on scores calculated for the inputted topic.

2. The computing system of claim 1, wherein self-reporting data for a given user includes a set of topics submitted by the given user as an area of expertise.

3. The computing system of claim 1, wherein the workspace interactions includes a running count of interactions by users with resources provisioned by the enterprise workspace platform.

4. The computing system of claim 1, wherein the document activity includes analyzing documents within the enterprise workspace platform to identify associations between users and topics.

5. The computing system of claim 1, wherein the inputted topic is determined from a natural language input into a user experience (UX) interface by the requesting user.

6. The computing system of claim 5, wherein a link to the expert user is provided within the UX interface.

7. The computing system of claim 1, wherein the score for each association is computed with a decay factor that reduces the score for an association over time.

8. A method for identifying experts amongst a set of users that engage with an enterprise workspace platform, the method including:
associating each user with a set of topics and calculating a score for each association, wherein associations and scores are determined by analyzing self-reporting data, workspace interactions and document activity;
receiving a natural language (NL) input from a requesting user in a user experience (UX) interface;
processing the NL input to determine a topic; and
identifying and displaying an expert user based on scores calculated for the topic.

9. The method of claim 8, wherein self-reporting data for a given user includes a set of topics submitted by the given user as an area of expertise.

10. The method of claim 8, wherein the workspace interactions includes a running count of interactions by users with applications provisioned by the enterprise workspace platform.

11. The method of claim 8, wherein the document activity includes analyzing documents within the enterprise workspace platform to identify associations between users and topics.

12. The method of claim 8, wherein the NL input is entered into one of an email program and a customer support tool by the requesting user.

13. The method of claim 12, wherein a link to the expert user is provided within the UX interface.

14. The method of claim 8, wherein the score for each association is computed with a decay factor that reduces the score for the association over time.

15. A computer program product stored on a computer readable storage medium, which when executed by a computing system, implements a method for identifying experts amongst a set of resources that engage with an enterprise workspace platform, wherein the method comprises:
associating each resource with a set of topics and calculating a score for each association, wherein associations and scores are determined by analyzing self-reporting data, workspace interactions and document activity;
receiving an inputted topic from a requesting user; and
identifying an expert based on scores calculated for the inputted topic.

16. The program product of claim 15, wherein self-reporting data for a given resource includes a set of topics submitted by a user as an area of expertise.

17. The program product of claim 15, wherein the workspace interactions includes a running count of interactions by resources with resources provisioned by the enterprise workspace platform.

18. The program product of claim 15, wherein the document activity includes analyzing documents within the enterprise workspace platform to identify associations between resources and topics.

19. The program product of claim 15, wherein the inputted topic is determined from a natural language input into a user experience (UX) interface by the requesting user and wherein a link to the expert is provided within the UX interface.

20. The program product of claim 15, wherein the score for each association is computed with a decay factor that reduces the score for the association over time.
